(19) United States
(12) Patent Application Publication
(10) Pub. No.: US 2025/0326460 A1
(43) Pub. Date: Oct. 23, 2025

(54) DRIVE UNIT AND ELECTRICALLY ASSISTED BICYCLE

(71) Applicant: YAMAHA HATSUDOKI KABUSHIKI KAISHA, Iwata-shi (JP)

(72) Inventors: Shota UDA, Shizuoka (JP); Ryo YOSHIDA, Shizuoka (JP); Toshio KOGA, Shizuoka (JP)

(21) Appl. No.: 19/182,673

(22) Filed: Apr. 18, 2025

(30) Foreign Application Priority Data
Apr. 19, 2024 (JP) 2024-068543

(51) Int. Cl. B62M 6/55

(52) U.S. Cl. CPC B62M 6/55

(57) ABSTRACT

A drive unit of an electrically assisted bicycle includes a housing, a crank shaft extending through a first wall and a second wall of the housing and rotatably supported by the housing, a motor inside the housing, a cover inside and attached to the housing to cover at least a portion of the motor, and a speed reducing mechanism between the cover and the second wall inside the housing. The cover includes a bulging portion bulging outward from the motor when viewed from an axial direction of the crank shaft. The speed reducing mechanism includes a first speed reducer rotatably supported by the cover and the second wall so that a rotational axis center of the first speed reducer is located at the bulging portion when viewed from the axial direction of the crank shaft.

### CROSS REFERENCE TO RELATED APPLICATIONS

This application claims the benefit of priority to Japanese Patent Application No. 2024-068543 filed on Apr. 19, 2024. The entire contents of this application are hereby incorporated herein by reference.

### BACKGROUND OF THE INVENTION

### 1. Field of the Invention

The present invention relates to drive units and electrically assisted bicycles, and more specifically to drive units including motors, and electrically assisted bicycles including the same.

### 2. Description of the Related Art

As an example which is pertinent to conventional techniques of this kind, JP-A 2021-62689 discloses a drive unit which is attached to a body frame of an electrically assisted bicycle to generate a driving force transmitted to a wheel. The drive unit has a housing, an electric motor disposed inside the housing, a pedal crank shaft extending through the housing in a left-right direction of the electrically assisted bicycle, and a speed reducer to reduce rotation generated by the electric motor. The housing includes a first case having a recess for accommodating the electric motor, a second case which constitutes an outer hull of the housing together with the first case, and an inner lid covering at least a portion of the electric motor housed in the recess of the first case. The inner lid rotatably supports a gear rotation shaft of the speed reducer. Further, an outer circumferential edge of the inner lid passes between the gear rotation shaft and the pedal crank shaft. The recess of the first case has a wall along a circumference of the electric motor. The wall supports the inner lid. When the inner lid is viewed from a direction parallel to the output shaft of the electric motor, an outer circumferential edge of the inner lid is along the circumference of the electric motor.

According to the drive unit disclosed in JP-A 2021-62689, the recess's wall which supports the inner lid has a high stiffness such that it is possible to reduce positional deviation of the inner lid. This arrangement makes it possible to reduce positional deviation of the gear rotation shaft of the speed reducer supported by the inner lid. Also, the inner lid is small in size, i.e., the inner lid does not extend toward the pedal crank shaft. This makes it possible to increase the stiffness of the inner lid. This arrangement also makes it possible to reduce positional deviation of the gear rotation shaft of the speed reducer supported by the inner lid.

As described above, it is possible to maintain the stiffness inside the drive unit. However, JP-A 2021-62689 discloses nothing about forming the inner lid so that its outer circumferential edge protrudes out of the circumference of the electric motor for efficient use of the inner lid.

### SUMMARY OF THE INVENTION

Example embodiments of the present invention provide drive units including covers usable in an efficient manner, and electrically assisted bicycles including the same.

According to an example embodiment of the present invention, a drive unit includes a housing including a first wall and a second wall facing the first wall, an input shaft extending through the first wall and the second wall and rotatably supported by the housing, a motor inside the housing, a cover inside and attached to the housing to cover at least a portion of the motor, and a speed reducing mechanism inside the housing between the cover and the second wall to reduce a rotation speed of the motor. The cover includes a bulging portion extending outward from the motor when viewed from an axial direction of the input shaft, and the speed reducing mechanism includes a first speed reducer rotatably supported by the cover and the second wall so that a rotational axis center of the first speed reducer is located at the bulging portion when viewed from the axial direction of the input shaft.

According to an example embodiment of the present invention, the cover covers at least a portion of the motor and is attached to the housing to function as a reinforcing structure of the housing, making it possible to substantially improve stiffness of the housing. The first speed reducer is rotatably supported by the cover and the second wall so that the rotational axis center of the first speed reducer is located at the bulging portion which does not cover the motor when viewed from the axial direction of the input shaft. Therefore, it is possible to space apart the rotational axis center of the first speed reducer from a rotational axis center of the motor. This makes it possible to improve the freedom of layout of the speed reducing mechanism and make efficient use of the cover.

Preferably, the bulging portion has a non-supported portion not supported by the housing, and the drive unit further includes a wiring space between the non-supported portion and the first wall. In this case, by utilizing the non-supported portion of the bulging portion, it is possible to easily provide the wiring space between the non-supported portion and the first wall. By routing wires through the wiring space, it is possible to keep the wires away from the gear of the first speed reducer and other structural elements. Therefore, it is possible with the cover, without providing additional separate structures, to prevent the wires from moving and coming into contact with and/or being entangled in the gear or other structural elements.

Further preferably, the non-supported portion includes a first recess facing the first wall. In this case, the arrangement makes it possible to use the first recess of the non-supported portion as a storage space to contain bent portions of the wires, couplers, etc.

Further, preferably, the first wall includes a second recess facing the first recess. In this case, it is possible with the first recess and the second recess that face each other to provide a large wiring space.

Preferably, when viewed from the axial direction of the input shaft, the wiring space overlaps a virtual line between an axial center of the input shaft and the rotational axis center of the first speed reducer. In this case, it is possible to shorten the wiring by routing the wires through the wiring space.

Further preferably, the drive unit further includes a torque sensor inside the housing and adjacent to the input shaft to detect a torque transmitted to the input shaft. With this arrangement, the bulging portion is configured to contact the torque sensor to function as a rotation stopper for the torque sensor. In this case, the bulging portion is extended until it is able to contact the torque sensor. Thus, it is possible to easily configure a rotation stopper for the torque sensor, and to smoothly control the rotation of the torque sensor with the bulging portion. Also, this arrangement provides a high level of design freedom in the height of the bulging portion in the axial direction of the input shaft.

Further, preferably, the drive unit further includes a circuit substrate inside the housing between the cover and the second wall and attached at least to the bulging portion. In this case, it is possible to attach the circuit substrate to the bulging portion using an empty space inside the housing, i.e., it is possible to use the cover to secure the substrate. This also makes it possible to ground the electric circuit. Also, by using the cover to secure the substrate, it is unnecessary to provide bosses in the housing to secure the substrate. Therefore, it is possible to increase the space for wiring and/or decrease the size of the housing.

Preferably, the drive unit further includes a circuit substrate inside the housing between the cover and the second wall, and connected with the bulging portion in a thermally conductive manner. In this case, it is possible to connect the circuit substrate with the bulging portion in a thermally conductive manner using an empty space inside the housing and make the cover function as a heat dissipator. Therefore, it is not necessary to provide a heat dissipator in the circuit substrate, or it is possible to decrease the size of the heat dissipator in the circuit board. As a result, this improves the freedom of layout of the electronic parts and/or makes it possible to reduce the size of the housing.

Further preferably, the cover includes a bearing support coaxial with the rotational axis center of the first speed reducer, and the drive unit further includes a bearing between the first speed reducer and the bearing support. In this case, at least a portion of the bearing support is located at the bulging portion of the cover. Thus, it is possible with the bearing support to support the bearing to rotatably support the first speed reducer.

Further, preferably, the bulging portion includes a through-hole, the first wall includes a third recess at a location corresponding to the through-hole, and the drive unit further includes a knock pin inserted into the through-hole and the third recess. In this case, the knock pin is inserted through the through-hole of the bulging portion and then into the third recess of the first wall. This arrangement makes it possible to attach the cover to the housing.

Preferably, the speed reducing mechanism further includes a second speed reducer rotatably supported by the cover and the second wall to reduce a rotation speed of the motor transmitted to the first speed reducer. In this case, it is possible, with the cover and the second wall, to rotatably support the first speed reducer and the second speed reducer, i.e., support a plurality of speed reducers.

Further preferably, the input shaft includes a first end and a second end opposite from the first end on a side where a drive sprocket is located, and the motor is located on a side of the first end when viewed from a direction perpendicular to the axial direction of the input shaft. Thus, the motor and the drive sprocket are located on opposite sides from each other in the axial direction of the input shaft.

A drive unit according to an example embodiment of the present invention is suitably applied to an electrically assisted bicycle.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view which shows an electrically assisted bicycle including a drive unit according to an example embodiment of the present invention.

FIG. 2 is a front perspective view which shows the drive unit.

FIG. 3 is a right side view which shows the drive unit.

FIG. 4 is a left side view which shows the drive unit.

FIG. 5 is a plan view which shows the drive unit.

FIG. 6 is a sectional diagram taken along line A-A in

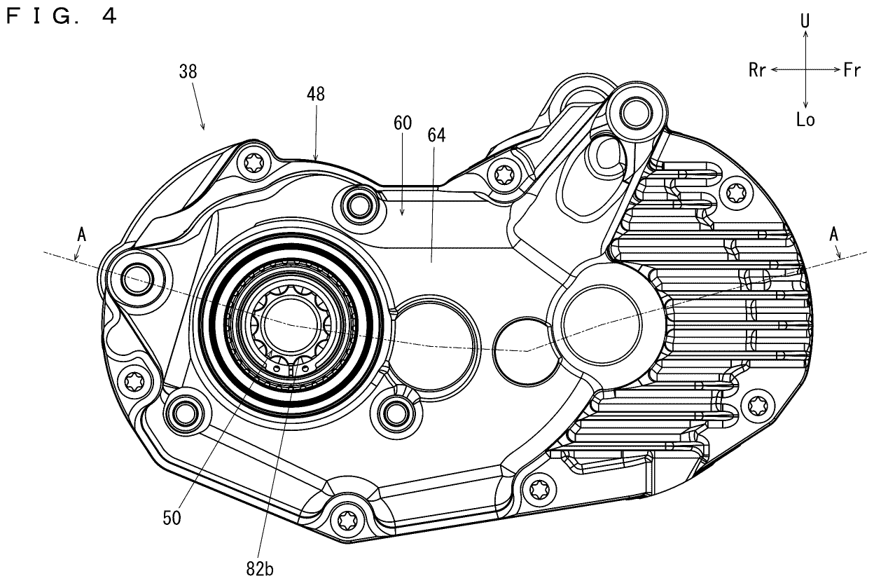

FIG. 4.

FIG. 7 is a diagram which shows a state where a motor is housed in a first case.

FIG. 8 is a diagram which shows the first case in FIG. 7 in a state with a crank shaft, a torque sensor, etc. attached thereto.

FIG. 9 is a diagram which shows the first case in FIG. 8 in a state with a cover attached thereto.

FIG. 10 is a left side view which shows the cover.

FIG. 11 is a right side view which shows the cover.

FIG. 12 is a plan view which shows the cover.

FIG. 13 is a diagram which shows the first case in FIG. 9 in a state with a circuit substrate and other structural elements attached thereto.

FIG. 14 is a diagram which shows the first case in

FIG. 13 in a state with an output shaft, a speed reducing mechanism, etc. attached thereto.

FIG. 15 is a diagram which shows a variation of the cover.

FIG. 16 is a diagram which shows a variation of the cover and the torque sensor.

FIG. 17 is a diagram which shows a variation of the cover and the circuit substrate.

FIG. 18 is a diagram which shows another variation of the cover and the circuit substrate.

### DETAILED DESCRIPTION OF THE EXAMPLE EMBODIMENTS

Hereinafter, example embodiments of the present invention will be described with reference to the drawings.

In the example embodiments of the present invention, the terms front and rear, left and right, and up and down of a drive unit 38 refer to front and rear, left and right, and up and down based on the state where the drive unit 38 is installed on an electrically assisted bicycle 10. In the drawings, “Fr” indicates forward, “Rr” indicates rearward, “R” indicates rightward, “L” indicates leftward, “U” indicates upward and “Lo” indicates downward.

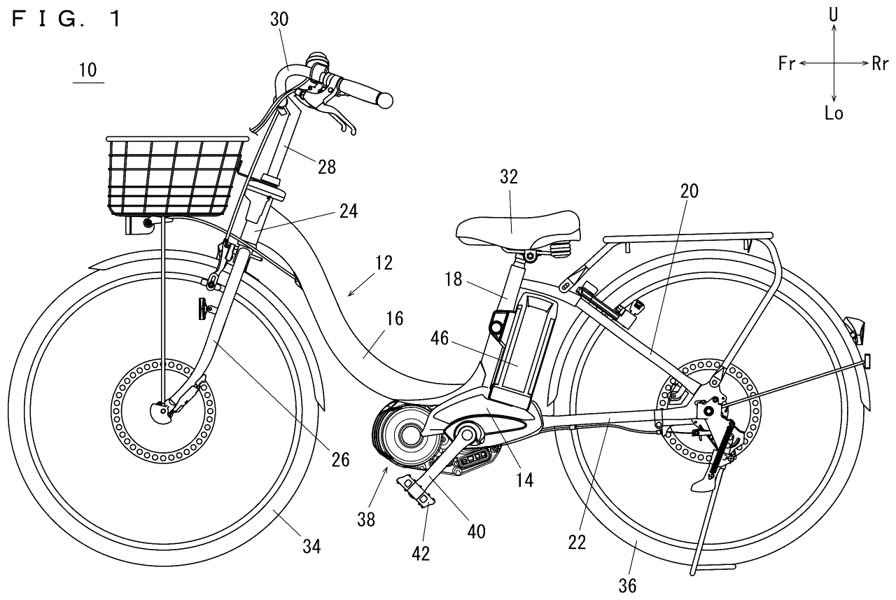

Referring to FIG. 1, an electrically assisted bicycle 10 according to an example embodiment of the present invention includes a frame 12. The frame 12 includes a bottom bracket 14, a down tube 16, a seat post 18, a pair of seat stays 20, a pair of chain stays 22, a head tube 24, and a front fork 26.

The down tube 16 extends in a curved fashion, diagonally up and forward from the bottom bracket 14. The seat post 18 extends upward but slightly titled rearward from the bottom bracket 14. The pair of chain stays 22 extend rearward from the bottom bracket 14. The pair of seat stays 20 connect an upper portion of the seat post 18 with rear ends of the pair of chain stays 22. The head tube 24 is connected with a front end of the down tube 16. The front fork 26 is inserted rotatably into the head tube 24, and is slightly tilted rearward.

A handlebar stem 28 is attached to an upper end of the front fork 26. The handlebar stem 28 supports a handlebar 30. The seat post 18 supports a saddle 32. Lower ends of the front fork 26 rotatably support a front wheel 34. Rear ends of the pair of chain stays 22 rotatably support a rear wheel 36.

A drive unit 38 is attached to the bottom bracket 14. The drive unit 38 will be described in detail below.

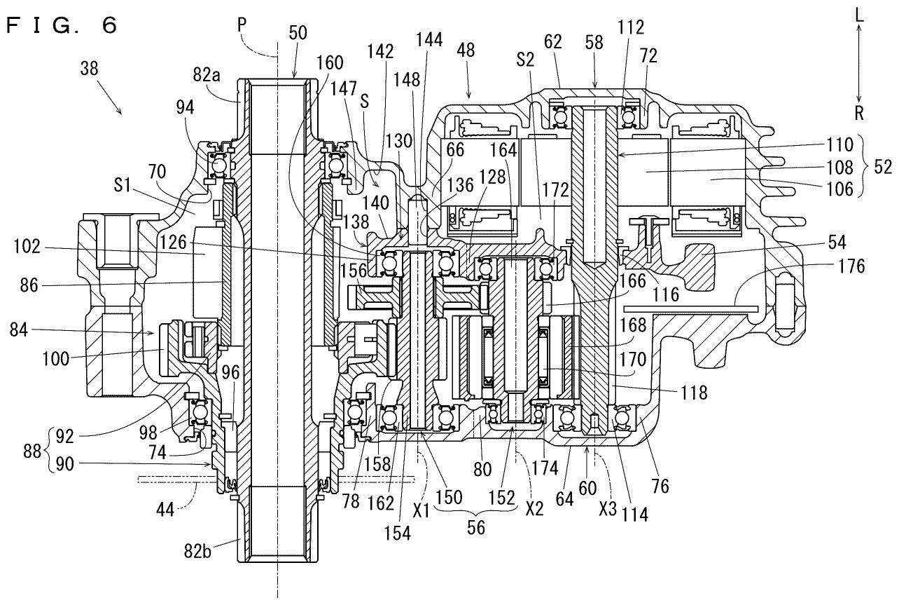

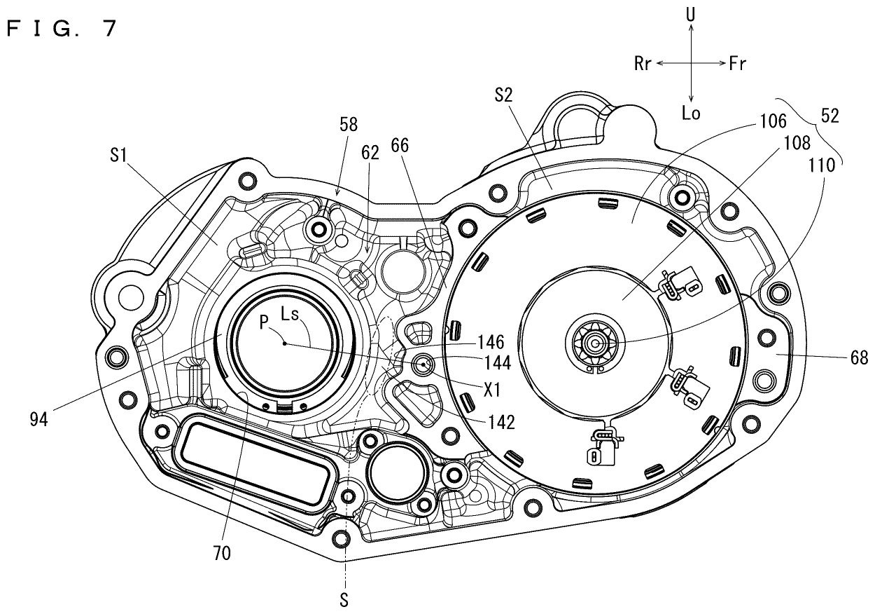

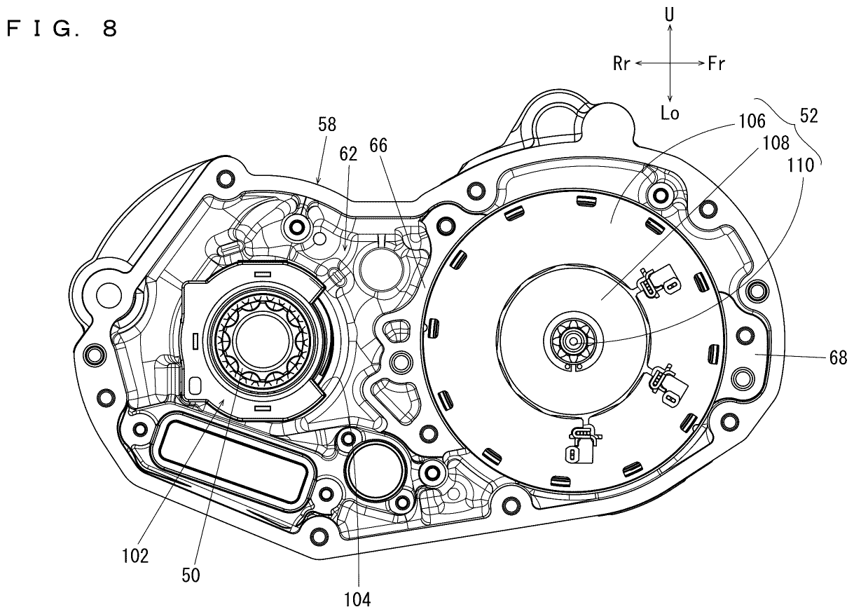

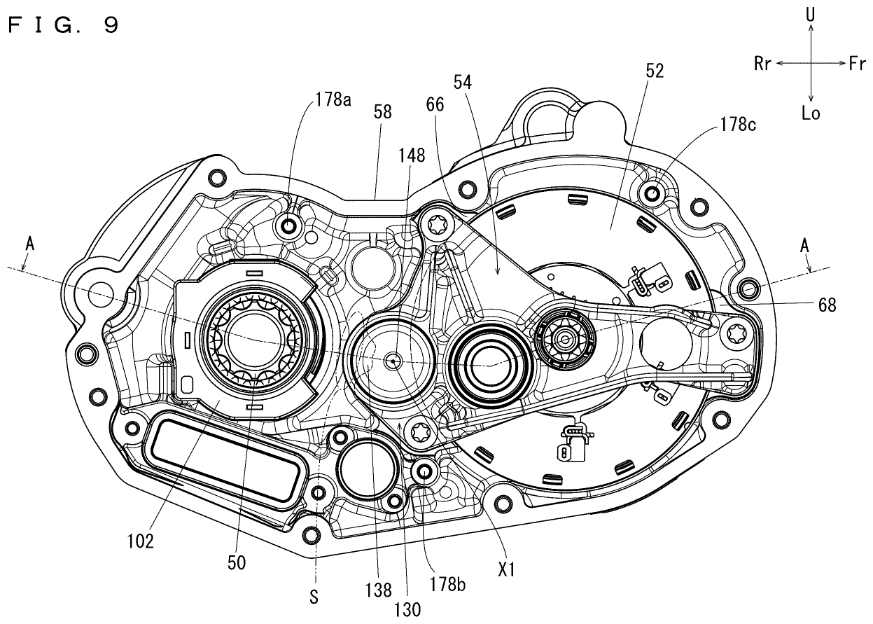

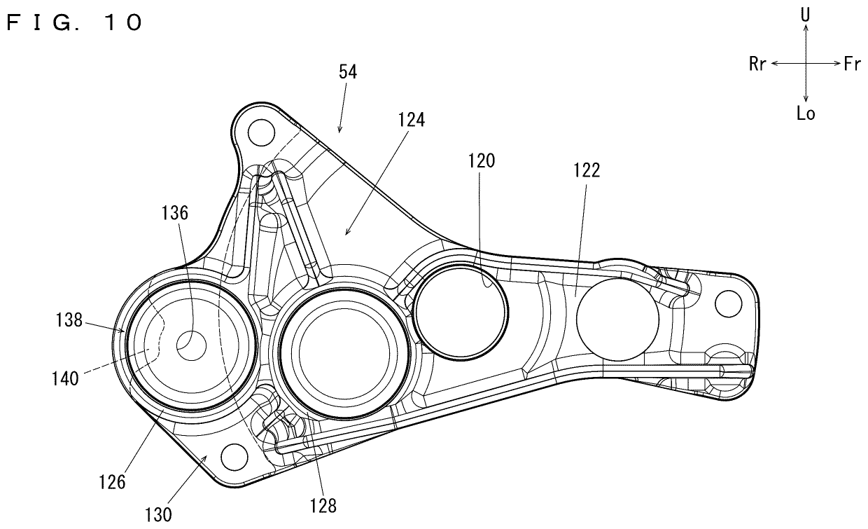

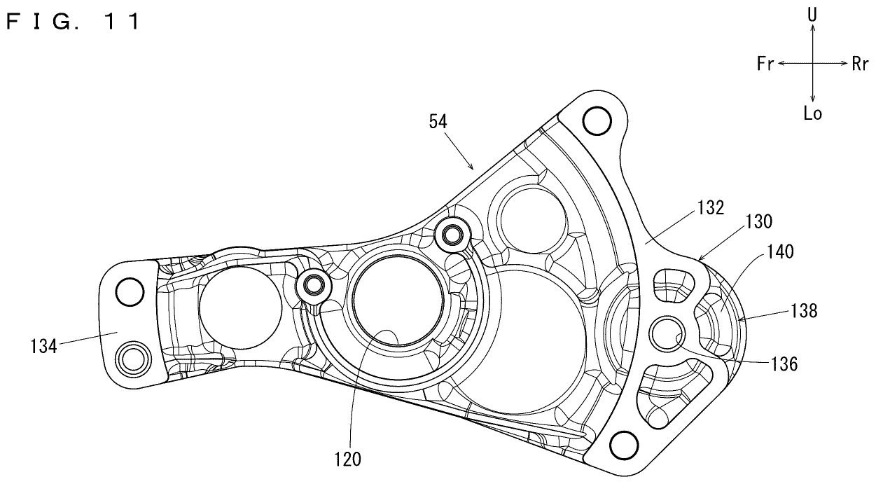

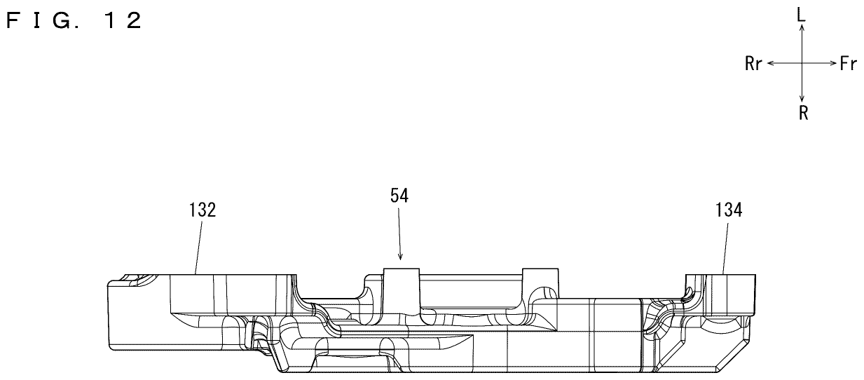

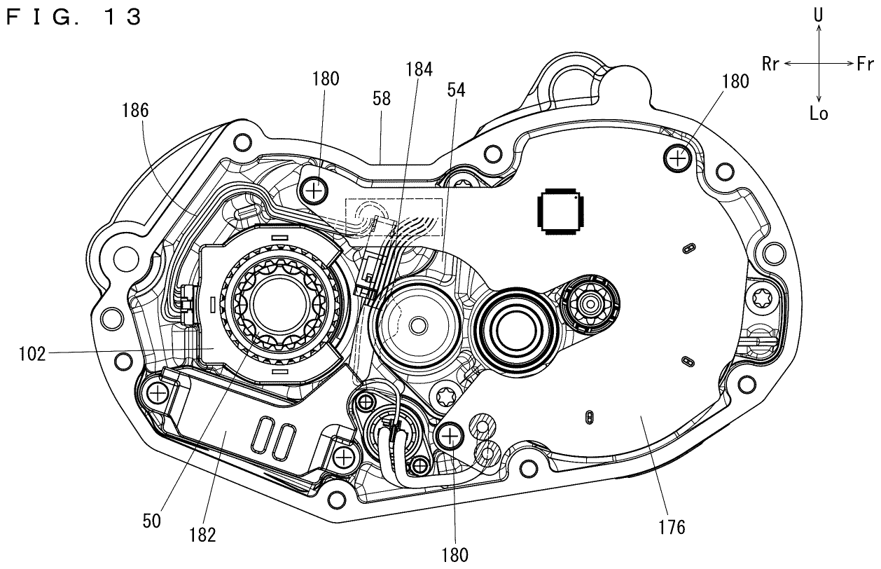

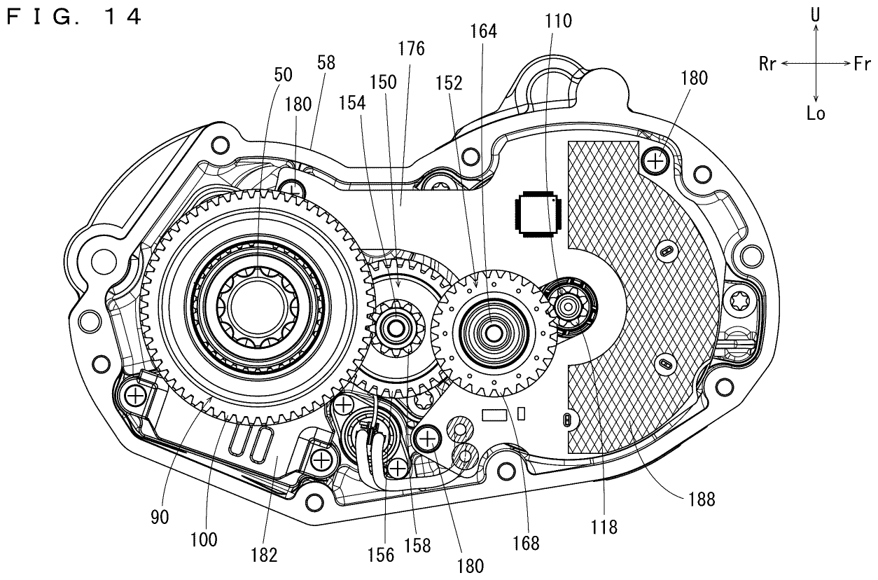

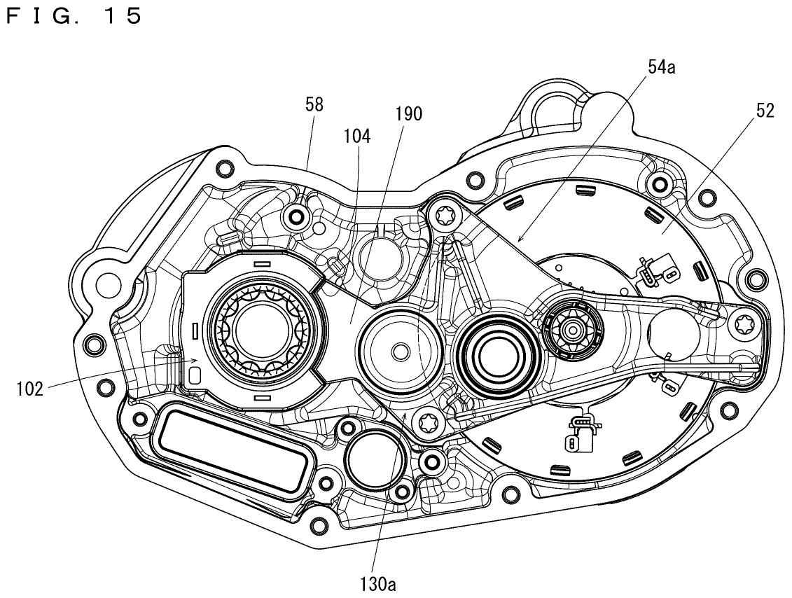

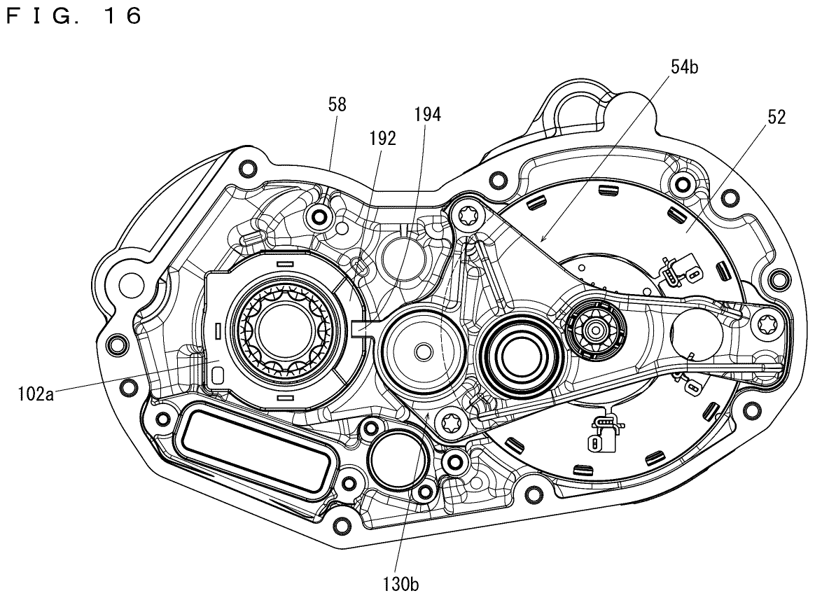

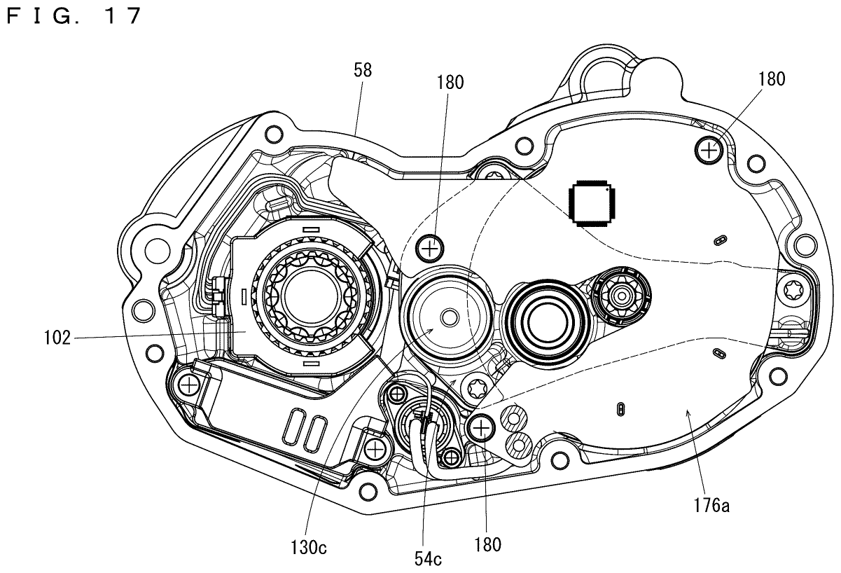

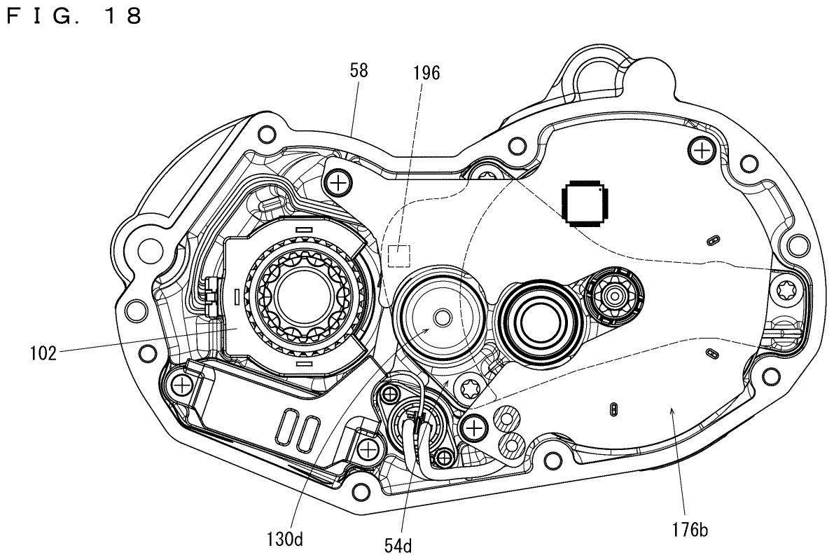

The drive unit 38 includes a crank shaft 50 (which will be described below) including two ends, i.e., a first end 82a and a second end 82b (which will be described below), to which a pair of crank arms 40 are attached. Each crank arm 40 includes a pedal 42 attached to its end. The drive unit 38 includes an output shaft 84 (which will be described below) having its end (right end in the present example embodiment) provided with a drive sprocket 44 attached thereto (see FIG. 6). The drive sprocket 44 is located near the second end (right end in the present example embodiment) 82b of the crank shaft 50, and moves together with the output shaft 84. The rear wheel 36 includes a rear sprocket (not illustrated). The drive sprocket 44 and the rear sprocket are connected with each other via a chain (not illustrated).

An inverter and a controller including, e.g., a CPU, are located near the bottom bracket 14. A battery 46 is attached to the seat post 18. The inverter converts DC power from the battery 46 into AC power based on instructions from the controller and provides the power to a motor 52 (which will be described below). The motor 52 generates a driving force with the supplied AC power. The driving force is transmitted to the drive sprocket 44 via a speed reducing mechanism 56 (which will be described below) and the output shaft 84.

Upon input of a tread force from the pedals 42, the drive unit 38 generates a drive assisting output with the motor 52 in accordance with the tread force to assist the tread force. The drive sprocket 44 rotates as the crank arms 40 rotate, and also receives the output from the motor 52. The drive unit 38 transmits to the drive sprocket 44 the tread force from the pedals 42 and the crank arms 40, and the output from the motor 52. The force transmitted to the drive sprocket 44 is transmitted to the rear wheel 36 via the chain.

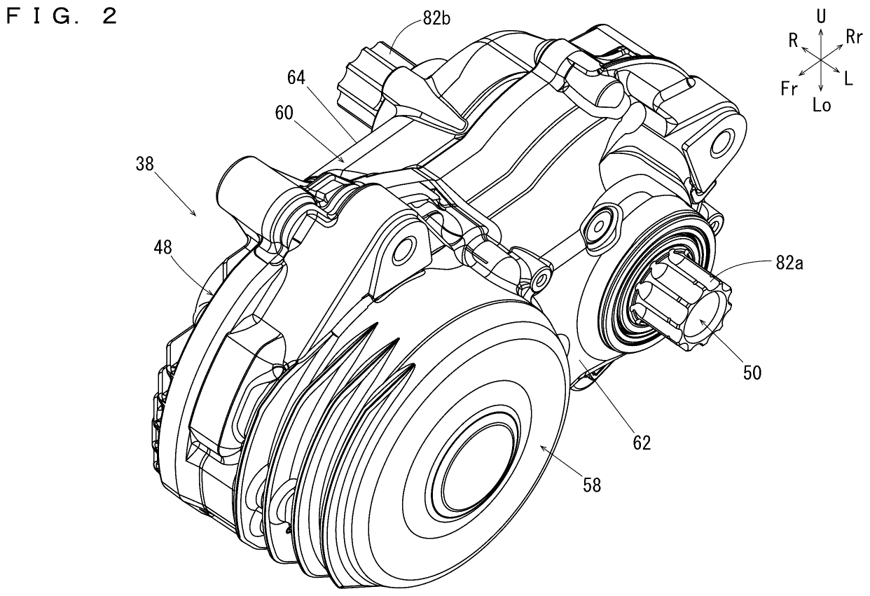

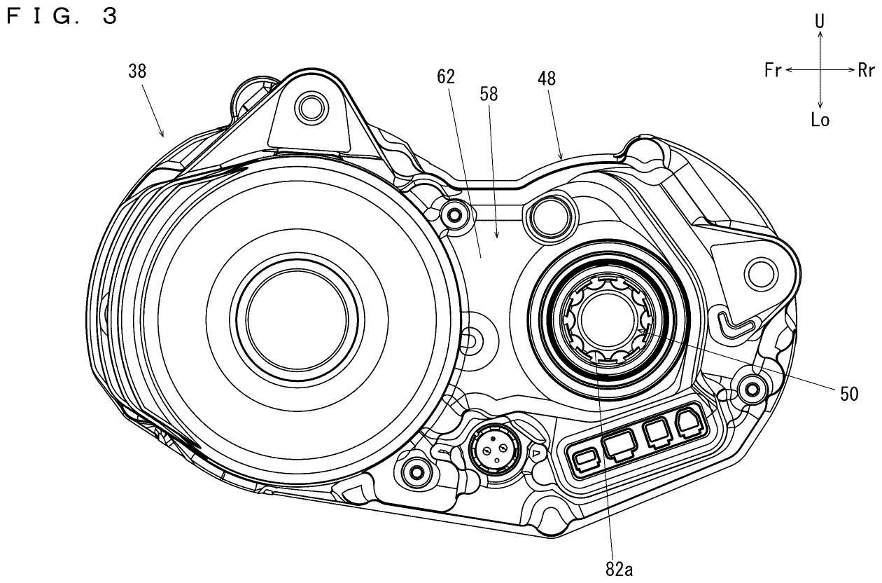

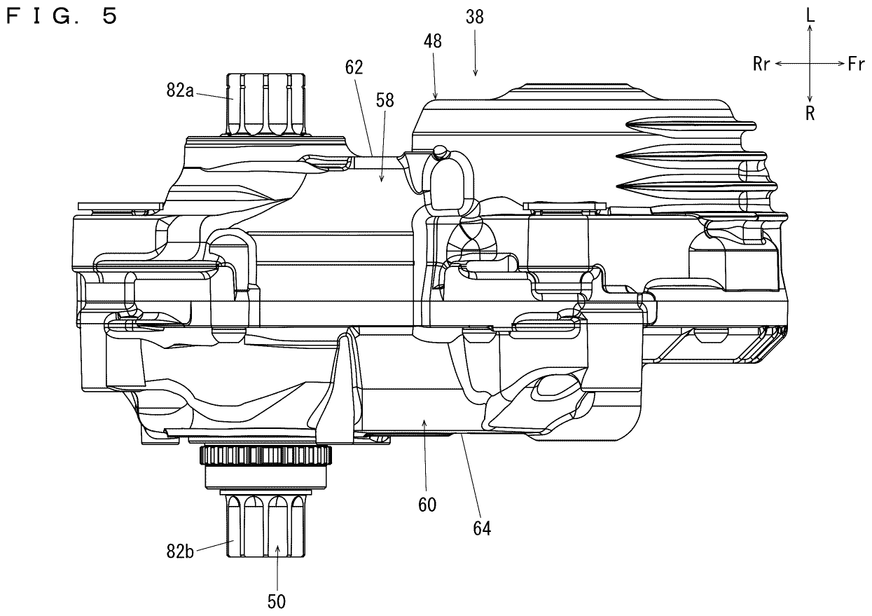

Referring to FIG. 2 through FIG. 6, the drive unit 38 includes a housing 48, the crank shaft 50, the motor 52, a cover 54, and the speed reducing mechanism 56.

The housing 48 has a two-part structure (left and right halves in the present example embodiment), including a first case 58 and a second case 60. The first case 58 and the second case 60 include a first wall 62 and a second wall 64 respectively. When the first case 58 and the second case 60 are fitted together, the first wall 62 and the second wall 64 face each other.

Referring further to FIG. 7, the first wall 62 includes inner walls 66, 68. The cover 54 is attached to the inner walls 66, 68. The first case 58 is divided by the inner wall 66 into a space S1 closer to the crank shaft 50, and a space S2 closer to the motor 52. On the space S1 side of the first wall 62, a through-hole 70 is provided for the crank shaft 50 to extend therethrough. In an inner surface of the first wall 62 on the space S2 side, a bearing support 72 is provided for the motor 52 at an approximate center of the space S2.

In the second wall 64, a through-hole 74 is provided for the crank shaft 50 to extend therethrough. In an inner surface of the second wall 64, a bearing support 76 is provided for the motor 52. The through-hole 74 is provided at a location corresponding to the through-hole 70. The bearing support 76 faces the bearing support 72. In the second wall 64, a bearing supports 78, 80 are provided for the speed reducing mechanism 56 between the through-hole 74 and the bearing support 76.

The crank shaft 50 includes the first end 82a and the second end 82b opposite from the first end 82a on a side where a drive sprocket 44 is located. The crank shaft 50 extends through the through-holes 70, 74, with the first end 82a and the second end 82b protruding out of the housing 48, i.e., out of the first case 58 and the second case 60. Thus, the crank shaft 50 extends through the first wall 62 and the second wall 64.

The crank shaft 50 has its outer circumference fitted with the output shaft 84. The output shaft 84 includes a connecting shaft 86 and a one-way clutch 88. The connecting shaft 86 is cylindrical, connected with the crank shaft 50 by spline fitting, and rotatable together with the crank shaft 50. The one-way clutch 88 includes an outer portion 90 and an inner portion 92 provided inside the outer portion 90. A bearing 94 is provided between the crank shaft 50 and the through-hole 70. The outer portion 90 is connected with the connecting shaft 86 via the inner portion 92. A bearing 96 is provided between the outer portion 90 and the crank shaft 50. A bearing 98 is provided between the outer portion 90 and the through-hole 74. Therefore, the crank shaft 50 is supported rotatably by the housing 48. The outer portion 90 is rotatable with respect to the housing 48 and the crank shaft 50. Forward rotation of the crank shaft 50 is transmitted to the one-way clutch 88 via the connecting shaft 86 making the outer portion 90 rotate forward. On the other hand, due to the one-way clutch 88, forward rotation of the outer portion 90 is not transmitted to the crank shaft 50. The outer portion 90 includes a gear 100.

Referring further to FIG. 8, inside the housing 48, a torque sensor 102 is provided around the connecting shaft 86, i.e., near the crank shaft 50. The torque sensor 102 has an outer shape like the letter C and includes a recess 104. The torque sensor 102 is supported by the first case 58. With the torque sensor 102, it is possible to detect a torque transmitted to the crank shaft 50 and eventually to the connecting shaft 86 when the pedals 42 are operated. The torque sensor 102 detects a torque generated in the crank shaft 50 when the pedals 42 are operated.

The motor 52 includes a stator 106, a rotor 108, and a rotor shaft 110, and is provided inside the housing 48. When viewed from a direction perpendicular to an axial direction of the crank shaft 50, the motor 52 is located on the first end 82a side (on the left side in the present example embodiment). The stator 106 is substantially hollow and cylindrical, located in the space S2 of the first case 58, and attached to the inside of the first case 58. The rotor shaft 110 is supported rotatably by the first case 58, the second case 60 and the cover 54. Thus, an end of the rotor shaft 110 is supported by the first wall 62 via a bearing 112 fitted in the bearing support 72 while the other end of the rotor shaft 110 is supported by the second wall 64 via a bearing 114 fitted in the bearing support 76. Further, a generally intermediate region of the rotor shaft 110 is supported by the cover 54 via a bearing 116 such that the rotor shaft 110 is rotatable inside the housing 48. The rotor 108 is fitted to an outer circumference of the rotor shaft 110 so that an outer circumferential surface of the rotor 108 and an inner circumferential surface of the stator 106 face each other, and is attached to the rotor shaft 110 rotatably together with the rotor shaft 110. The rotor shaft 110 includes an output gear 118.

Referring further to FIG. 9, the cover 54 is provided inside the housing 48 so as to cover at least a portion of the motor 52, and is attached to the first case 58 of the housing 48. The cover 54 may be made of metal, is substantially flat, like the shape of a spatula for example, and extends in a fore-aft direction. Therefore, when viewed from the axial direction of the crank shaft 50, portions of the motor 52 located on two sides (upper and lower sides in this example embodiment) of the cover 54 are not covered by the cover 54.

Referring to FIG. 10 through FIG. 12, the cover 54 includes a through-hole 120 to receive the rotor shaft 110 at its generally intermediate region. The cover 54 includes a narrower portion 122 on one side (forward side in the present example embodiment) spaced apart from the through-hole 120, and a wider portion 124 on the other side (rearward side in the present example embodiment) spaced apart from the through-hole 120. The wider portion 124 includes a main surface facing the second wall 64, and is provided with bearing supports 126, 128 for the speed reducing mechanism 56. The bearing supports 126, 128 face the bearing supports 78, 80 of the second wall 64 respectively. The bearing support 126 is coaxial with a rotational axis center X1 of a first speed reducer 150 (which will be described below). The bearing support 128 is coaxial with a rotational axis center X2 of a second speed reducer 152 (which will be described below) (see FIG. 6).

The cover 54, more specifically, the wider portion 124, includes a bulging portion 130 extending outward of the motor 52 when viewed in the axial direction of the crank shaft 50 (see FIG. 9). The bulging portion 130 extends outward from an outline of the stator 106. In the present example embodiment, the bulging portion 130 is provided at an end of the wider portion 124. The bulging portion 130 includes a main surface facing the first wall 62, where a flat surface portion 132 makes surface contact with the inner wall 66 of the first wall 62. The flat surface portion 132 has substantially the same shape as a contact surface of the inner wall 66. An end of the narrower portion 122 includes a main surface facing the first wall 62, where a flat surface portion 134 makes surface contact with the inner wall 68 of the first wall 62. This makes it possible to bring a larger area into contact between the cover 54 and the inner walls 66, 68 to better support the housing 48.

The bulging portion 130 includes a through-hole 136. The through-hole 136 is located at a center of the bearing support 126, more specifically, substantially at a center of the flat surface portion 132.

Also, the bulging portion 130 includes a non-supported portion 138, which is not supported by the housing 48, at its end (rear end in the present example embodiment). The non-supported portion 138 is located at an end of the bulging portion 130 where the flat surface portion 132 is not provided, and on an outside of the through-hole 136. The non-supported portion 138 includes a first recess 140 facing the first wall 62.

Referring to FIG. 6 and FIG. 7, the first wall 62 includes a second recess 142 at a location facing the first recess 140. The inner wall 66 of the first wall 62 includes a third recess 144 and a fourth recess 146. Between the through-hole 70 and the inner wall 66, a rib 147 protrudes inward of the first wall 62 providing the second recess 142 between the rib 147 and the inner wall 66. The third recess 144 is provided at a location corresponding to the through-hole 136. The fourth recess 146 is a recess in the surface of the inner wall 66 and faces the crank shaft 50 (rear surface in the present example embodiment) toward the through-hole 136. When the cover 54 is attached to the first wall 62, a knock pin 148 is inserted into the through-hole 136 and the third recess 144.

A wiring space S is provided between the non-supported portion 138 and the first wall 62. When viewed from the axial direction of the crank shaft 50, the wiring space S overlaps a virtual line Ls between an axial center P of the crank shaft 50 and the rotational axis center X1 of the first speed reducer 150 (see FIG. 7).

The speed reducing mechanism 56 is between the cover 54 and the second wall 64 inside the housing 48. The speed reducing mechanism 56 is also between the crank shaft 50 and the rotor shaft 110 inside the housing 48. The speed reducing mechanism 56 slows down rotation generated by the motor 52 and increases an output torque of the motor 52.

The speed reducing mechanism 56 includes the first speed reducer 150 and the second speed reducer 152.

Referring to FIG. 6 and FIG. 9, the first speed reducer 150 is rotatably supported by the cover 54 and the second wall 64 so that the rotational axis center X1 of the first speed reducer 150 is located at the bulging portion 130 when viewed from the axial direction of the crank shaft 50. The first speed reducer 150 includes a rotation shaft 154, a large-diameter gear 156, and a small-diameter gear 158. The rotation shaft 154 has its one end supported by the cover 54 via a bearing 160 fitted in the bearing support 126 while the other end of the rotation shaft 154 is supported by the second wall 64 via a bearing 162 fitted in the bearing support 78 such that the rotation shaft 154 is rotatable inside the housing 48.

The second speed reducer 152 is between the rotor shaft 110 and the first speed reducer 150, and supported rotatably by the cover 54 and the second wall 64. The second speed reducer 152 includes a rotation shaft 164, a small-diameter gear 166, a large-diameter gear 168, and a one-way clutch 170. The rotation shaft 164 has its one end supported by the cover 54 via a bearing 172 fitted in the bearing support 128 while the other end of the rotation shaft 164 is supported by the second wall 64 via a bearing 174 fitted in the bearing support 80 such that the rotation shaft 164 is rotatable inside the housing 48. The one-way clutch 170 is between the rotation shaft 164 and the gear 168 so that forward rotation of the rotor shaft 110 is transmitted to the rotation shaft 164 of the second speed reducer 152 but forward rotation of the rotation shaft 164 is not transmitted to the rotor shaft 110.

Referring further to FIG. 14, the gear 168 engages with the output gear 118 of the rotor shaft 110. The gear 166 engages with the gear 156. The gear 158 engages with the gear 100 of the outer portion 90 of the one-way clutch 88.

The first speed reducer 150 and the second speed reducer 152 reduce a rotation speed of the motor 52, increase the output torque of the motor 52, and transmit the rotation and the torque to the outer portion 90 of the output shaft 84.

Also, referring to FIG. 6, FIG. 13 and FIG. 14, a circuit substrate 176 is provided inside the housing 48 between the cover 54 and the second wall 64. The circuit substrate 176 is substantially Y shaped so as to avoid contact with the motor 52, the first speed reducer 150 and the second speed reducer 152. Referring further to FIG. 9, the circuit substrate 176 is attached to a plurality of bosses 178a, 178b, 178c in the first wall 62 with fasteners 180. A wire guide 182 is disposed between the first case 58 and the torque sensor 102. Wires 184 extending from the circuit substrate 176 are laid through the wiring space S, and then between the wire guide 182 and the first case 58. The wires 184 from the circuit substrate 176 are laid between the cover 54 and the first wall 62, which, when viewed from the axial direction of the crank shaft 50, is between the crank shaft 50 and the rotation shaft 154 of the first speed reducer 150, and then between the wire guide 182 and the first wall 62. The wires 184 are laid between the crank shaft 50 and the rotation shaft 154 of the first speed reducer 150 which is the speed reducer closest to the crank shaft 50 when viewed from the axial direction of the crank shaft 50. In the present example embodiment, wires 186 from the torque sensor 102 take a route which does not pass through the wiring space S and then are connected with the circuit substrate 176. A heat dissipation sheet 188 is attached to the circuit substrate 176.

In the present example embodiment, the crank shaft 50 corresponds to the input shaft.

According to the electrically assisted bicycle 10 including the drive unit 38 as described thus far, the cover 54 covers at least a portion of the motor 52 and is attached to the housing 48 such that the cover 54 functions as a reinforcing structure of the housing 48, thus substantially improving the stiffness of the housing 48. The first speed reducer 150 is rotatably supported by the cover 54 and the second wall 64 so that the rotational axis center X1 of the first speed reducer 150 is positioned at the bulging portion 130 which does not cover the motor 52 when viewed from the axial direction of the crank shaft 50. Therefore, it is possible to locate the rotational axis center X1 of the first speed reducer 150 spaced apart from a rotational axis center X3 of the motor 52. This makes it possible to improve the freedom of layout of the speed reducing mechanism 56. Thus, it is possible to make efficient use of the cover 54.

By utilizing the non-supported portion 138 of the bulging portion 130, it is possible to easily provide the wiring space S between the non-supported portion 138 and the first wall 62. By routing the wires 184 through the wiring space S, it is possible to contain the wires 184 spaced apart from the gears 156, 158 of the first speed reducer 150, the gear 100 of the outer portion 90, etc. Therefore, it is possible to use the cover 54, without providing additional separate structural elements, to prevent the wires 184 from moving and coming into contact with and/or being entangled in the gears 100, 156, 158, etc.

It is possible to use the first recess 140 of the non-supported portion 138 as a storage space to contain bent portions of the wires 184, couplers, etc.

With the first recess 140 and the second recess 142 which face each other, it is possible to provide a large wiring space S.

When viewed from the axial direction of the crank shaft 50, the wiring space S overlaps the virtual line Ls between the axial center P of the crank shaft 50 and the rotational axis center X1 of the first speed reducer 150. By routing the wires 184 through the wiring space S it is possible to shorten the wiring.

At least a portion of the bearing support 126 is located at the bulging portion 130 of the cover 54. It is possible, with the bearing support 126, to support the bearing 160 to rotatably support the first speed reducer 150.

The knock pin 148 is inserted through the through-hole 136 of the bulging portion 130 and then into the third recess 144 of the first wall 62. This arrangement makes it possible to attach the cover 54 to the housing 48.

With the cover 54 and the second wall 64, it is possible to rotatably support the first speed reducer 150 and the second speed reducer 152, i.e., support a plurality of speed reducers.

The cover 54 also functions as a guide for the wires 184, and therefore, it is possible to decrease the size of the wire guide 182.

In example embodiments of the present invention, similar to the drive unit 38, the motor 52 and the drive sprocket 44 are located on opposite sides from each other in the axial direction of the crank shaft 50.

The drive unit 38 according to an example embodiment of the present invention is suitably applied to the electrically assisted bicycle 10.

The cover may be configured as shown in FIG. 15.

A cover 54a shown in FIG. 15 includes a bulging portion 130a which is similar to the bulging portion 130 of the cover 54 but extending farther toward the torque sensor 102. The bulging portion 130a includes an engagement portion 190 which is engageable with the recess 104 of the torque sensor 102. Thus, the bulging portion 130a is configured to contact the torque sensor 102 to function as a rotation stopper for the torque sensor 102.

In this case, the bulging portion 130a is extended until it contacts the torque sensor 102. Thus, it is possible to easily configure a rotation stopper for the torque sensor 102, and to smoothly control the rotation of the torque sensor 102 with the bulging portion 130a. Also, this arrangement provides a high level of design freedom in the height of the bulging portion 130a in the axial direction of the crank shaft 50.

The cover and the torque sensor may be configured as shown in FIG. 16.

A torque sensor 102a shown in FIG. 16 includes a wall 192 facing a cover 54b. The cover 54b includes a bulging portion 130b which is similar to the bulging portion 130 of the cover 54 but extending farther toward the torque sensor 102a. The bulging portion 130b includes a protruding portion 194 that is able to be attached to the wall 192. By attaching the protruding portion 194 to the wall 192, the bulging portion 130b functions as a rotation stopper for the torque sensor 102a. In this case again, the arrangement provides the same advantages as the case utilizing the cover 54a shown in FIG. 15.

The cover and the circuit substrate may be configured as shown in FIG. 17.

FIG. 17 shows an example embodiment in which a cover 54c is a further enlarged version of the cover 54. More specifically, the cover 54c includes a bulging portion 130c which is similar to the bulging portion 130 of the cover 54 but further enlarged. Also, a circuit substrate 176a is an enlarged version of the circuit substrate 176. This arrangement makes it possible to increase an area of overlap between the cover 54c (bulging portion 130c) and the circuit substrate 176a. The cover 54c (bulging portion 130c) and the circuit substrate 176a are fastened to each other with fasteners 180 in the area where they overlap each other. Therefore, the circuit substrate 176a is attached at least to the bulging portion 130c. In the present example embodiment, the circuit substrate 176a is attached to the bulging portion 130c and the first case 58 of the housing 48.

In this case, it is possible to attach the circuit substrate 176a to the bulging portion 130c using an empty space inside the housing 48, i.e., it is possible to use the cover 54c to secure the substrate. This also makes it possible to ground the electric circuit. Also, by using the cover 54c to secure the substrate, it is unnecessary to provide bosses in the housing to secure the substrate. In the present example embodiment, the boss 178a (see FIG. 9) in the housing 48 need not be provided. In this case, it is possible to increase space for wiring and/or to decrease the size of the housing.

The cover and the circuit substrate may be configured as shown in FIG. 18.

FIG. 18 shows an example embodiment in which a cover 54d is a further enlarged version of the cover 54. More specifically, the cover 54d includes a bulging portion 130d which is similar to the bulging portion 130 of the cover 54 but further enlarged. Also, the circuit substrate 176b is an enlarged version of the circuit substrate 176. This arrangement makes it possible to increase an area of overlap between the cover 54d (bulging portion 130d) and the circuit substrate 176b. The cover 54d (bulging portion 130d) and the circuit substrate 176b are connected with each other within the area where they overlap each other, and in a thermally conductive manner via a thermally conductive portion 196. Therefore, it is possible to release heat generated in the circuit substrate 176b from the cover 54d via the thermally conductive material 196.

In this case, it is possible to connect the circuit substrate 176b with the bulging portion 130d in a thermally conductive manner using an empty space inside the housing 48 and make the cover 54d function as a heat dissipator. Therefore, it is not necessary to provide a separate heat dissipator (such as the heat dissipation sheet 188 shown in FIG. 14) in the circuit substrate 176b, or it is possible to decrease the size of the heat dissipator in the circuit board 176b. As a result, this improves the freedom of layout of the electronic elements and/or makes it possible to decrease the size of the housing.

The thermally conductive material 196 may be replaced with a spring to function as a grounding terminal for noise reduction.

In the example embodiments described above, description was made for a case where the speed reducing mechanism 56 includes the first speed reducer 150 and the second speed reducer 152. However, the present invention is not limited to this. For example, the speed reducing mechanism may only include the first speed reducer so that the driving force from the motor is reduced by the first speed reducer and then transmitted to the output shaft.

Example embodiments of the present invention are also applicable to a drive unit of a type where the motor is housed in the motor housing. In this case, the first case may include a motor housing which houses the stator of the motor, with the motor housing being configured as a separate structural element from the other portions of the first case. Also, in this case, the first wall extends from the motor housing to the above-mentioned other portions.

The circuit substrate may be attached only to the cover inside the housing.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A drive unit comprising:
a housing including a first wall and a second wall facing the first wall;
an input shaft extending through the first wall and the second wall and rotatably supported by the housing;
a motor inside the housing;
a cover inside and attached to the housing to cover at least a portion of the motor; and
a speed reducing mechanism inside the housing between the cover and the second wall to reduce a rotation speed of the motor; wherein
the cover includes a bulging portion extending outward from the motor when viewed from an axial direction of the input shaft; and
the speed reducing mechanism includes a first speed reducer rotatably supported by the cover and the second wall so that a rotational axis center of the first speed reducer is located at the bulging portion when viewed from the axial direction of the input shaft.

2. The drive unit according to claim 1, wherein
the bulging portion includes a non-supported portion that is not supported by the housing; and
the drive unit further comprises a wiring space provided between the non-supported portion and the first wall.

3. The drive unit according to claim 2, wherein the non-supported portion includes a first recess facing the first wall.

4. The drive unit according to claim 3, wherein the first wall includes a second recess facing the first recess.

5. The drive unit according to claim 2, wherein the wiring space overlaps a virtual line between an axial center of the input shaft and the rotational axis center of the first speed reducer when viewed from the axial direction of the input shaft.

6. The drive unit according to claim 1, further comprising:
a torque sensor inside the housing and adjacent to the input shaft to detect a torque transmitted to the input shaft; wherein
the bulging portion is configured to contact the torque sensor to function as a rotation stopper for the torque sensor.

7. The drive unit according to claim 1, further comprising a circuit substrate inside the housing between the cover and the second wall and attached at least to the bulging portion.

8. The drive unit according to claim 1, further comprising a circuit substrate inside the housing between the cover and the second wall and connected with the bulging portion in a thermally conductive manner.

9. The drive unit according to claim 1, wherein
the cover includes a bearing support coaxial with the rotational axis center of the first speed reducer; and
the drive unit further comprises a bearing between the first speed reducer and the bearing support.

10. The drive unit according to claim 1, wherein
the bulging portion includes a through-hole;
the first wall includes a third recess at a location corresponding to the through-hole; and
the drive unit further comprises a knock pin insertable into the through-hole and the third recess.

11. The drive unit according to claim 1, wherein the speed reducing mechanism further includes a second speed reducer rotatably supported by the cover and the second wall to reduce a rotation speed of the motor transmitted to the first speed reducer.

12. The drive unit according to claim 1, wherein
the input shaft includes a first end and a second end opposite from the first end on a side where a drive sprocket is located; and
the motor is located on a side of the first end when viewed from a direction perpendicular to the axial direction of the input shaft.

13. An electrically assisted bicycle comprising:
the unit according to claim 1.
